(19) United States
(12) Patent Application Publication
(10) Pub. No.: US 2018/0297451 A1
(43) Pub. Date: Oct. 18, 2018

(54) WIND BUFFETING SYSTEM FOR A VEHICLE

(71) Applicant: GM GLOBAL TECHNOLOGY OPERATIONS LLC, Detroit, MI (US)

(72) Inventor: Anthony K. Banner, Clarkston, MI (US)

(73) Assignee: GM GLOBAL TECHNOLOGY OPERATIONS LLC, Detroit, MI (US)

(21) Appl. No.: 15/488,749

(22) Filed: Apr. 17, 2017

(51) Int. Cl. B60J 1/20; B62D 35/00

(52) U.S. Cl. CPC B60J 1/2002; B60J 1/12; B62D 35/008

(57) ABSTRACT

A system and method of controlling wind buffeting for a vehicle includes a first window assembly movable between a closed position and at least one open position and a second window assembly movable between a closed position and at least one open position. A controller detects whether a speed of the vehicle exceeds a predetermined speed value and determines the position of the second window assembly when the vehicle speed exceeds the predetermined speed value. The position of the first window assembly is determined when the second window assembly is in the at least one open position. A buffeting member is adjusted from a first position to at least one second position in response to the controller determining the first window assembly is in the closed position.

### INTRODUCTION

The present disclosure relates to a wind buffeting system for a vehicle.

Air resistance produces drag forces on an automotive vehicle body. The drag forces become more pronounced at higher vehicle speeds. Automotive vehicle bodies and externally-attached components such as side mirrors are therefore typically designed with an aerodynamic shape to help maximize fuel economy and provide a desired level of vehicle acceleration and handling.

Regardless of how aerodynamic the design might be, the smooth laminar airflow passing over and around a moving vehicle body is disrupted when the front or rear windows of the vehicle are opened. The disrupted airflow may be perceived by an occupant of a vehicle interior as pulsations of air pressure, also known as wind buffeting or a buffeting condition. The buffeting condition is a naturally occurring phenomenon which results from the coupling of acoustic and hydrodynamic flows inside the passenger compartment that introduce strong pressure oscillations in the passenger compartment in a relatively low frequency (about 10 Hz to 50 Hz).

### SUMMARY

A method for controlling wind buffeting for a vehicle includes providing a first window assembly movable between a closed position and at least one open position and providing a second window assembly movable between a closed position and at least one open position. A controller detects whether a speed of the vehicle exceeds a predetermined speed value.

The controller determines the position of the second window assembly in response to the controller detecting that the speed of the vehicle exceeds the predetermined speed value. The controller determines the position of the first window assembly in response to the controller determining that the second window assembly is in the at least one open position.

A buffeting member is provided adjacent the second window assembly. The buffeting member includes a trim panel and an adjustment mechanism operatively connected to the trim panel to translate the trim panel between a first position and at least one second position. The buffeting member is adjusted from the first position to the at least one second position in response to the controller determining that the first window assembly is in the closed position.

The method for controlling wind buffeting includes a monitoring, with the controller, one or more vehicle operating conditions with at least one speed sensor in communication with the controller to detect the speed of the vehicle and at least one window position sensor in communication with one or more of the first window assembly and second window assembly to detect the position of windows of the first and second window assemblies between the first position and the at least one second position. The predetermined speed value is a vehicle speed threshold value greater than 10 miles per hour (mph).

The first window assembly is operatively connected to a first door movably connected to a vehicle body and the second window assembly is operatively connected to a second door movably connected to a vehicle body and disposed adjacent the first door on the vehicle body. The buffeting member is operatively connected a portion of the buffeting member to the second door adjacent the second window assembly and the adjustment mechanism of the buffeting member is a cam linkage. A spring is operatively connected to the trim panel to bias the trim panel between the first position and the at least one second position.

In another embodiment, a wind buffeting system for a vehicle having a first door movably connected to a vehicle body and a second door movably connected to the vehicle body and disposed adjacent to the first door is provided. The system includes a first window assembly operatively connected to the first door that is movable between a closed position and at least one open position. A second window assembly is operatively connected to the second door and is movable between a closed position and at least one open position.

A buffeting member is operatively connected to a portion of the second door adjacent the second window assembly. The buffeting member includes a trim panel and an adjustment mechanism operatively connected to the trim panel to adjust the trim panel between a first position and at least one second position.

A controller is operatively connected with the first and second window assemblies. The controller detects a speed of the vehicle to determine if the vehicle speed exceeds a predetermined speed threshold value and determines the position of the second window assembly in response to the controller detecting that the speed of the vehicle exceeds the predetermined speed threshold value. The controller determines the position of the first window assembly in response to the controller determining the second window assembly is in the at least one open position and adjusts the trim panel of the buffeting member from the first position to the at least one second position in response to the controller determining the first window assembly is in the closed position.

The predetermined speed value is a vehicle speed threshold value greater than 10 miles per hour (mph). The system includes a plurality of sensors in communication with the controller. The plurality of sensors includes at least one vehicle speed sensor to detect the vehicle speed and at least one window position sensor in communication with one or more of the first window assembly and second window assembly to detect the position of windows of the first and second window assemblies.

The buffeting member is operatively connected a portion of the second door adjacent the second window assembly and the adjustment mechanism of the buffeting member is a cam linkage. A spring is operatively connected to the trim panel to bias the trim panel between the first position and the at least one second position. The trim panel of the buffeting member at least partially covers a portion of a vehicle body when the trim panel is in the first position.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective view of a vehicle incorporating a wind buffeting system in accordance with the present disclosure;

FIG. 2 is schematic side view of the wind buffeting system in a deployed position on the vehicle;

FIG. 3 is a cross-sectional perspective view of the wind buffeting system along line 3-3 of FIG. 2; and

FIG. 4 is flowchart detailing the method of adjusting the wind buffeting system in accordance with the present disclosure.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure.

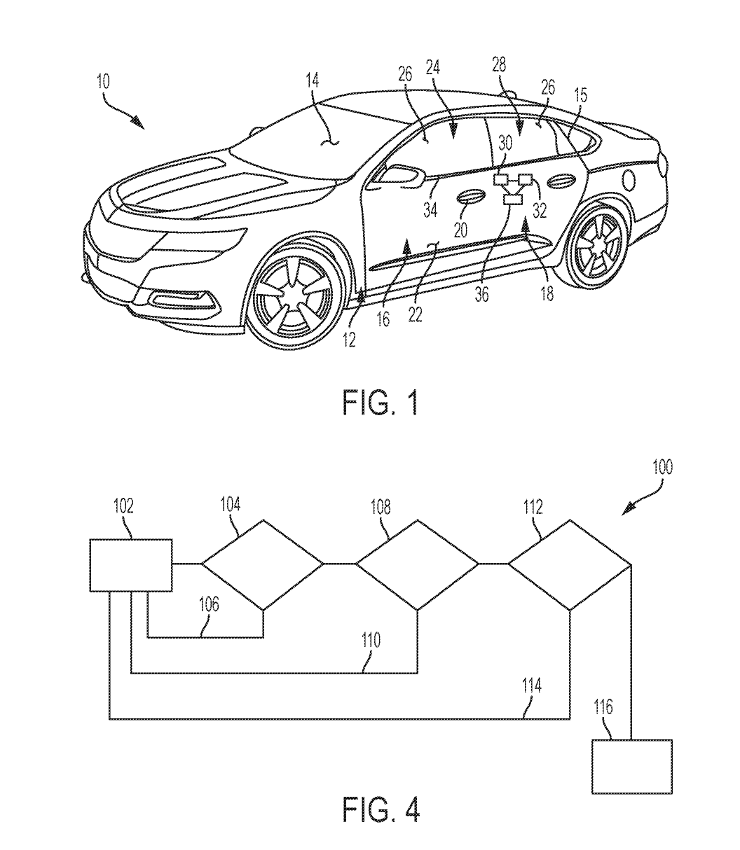

Referring to the drawings, wherein like reference numbers correspond to like or similar components throughout the several Figures, an example vehicle 10 is shown schematically in FIG. 1. The vehicle 10 may include, but not be limited to, a commercial vehicle, industrial vehicle, passenger vehicle, aircraft, watercraft, train or any mobile platform. It is also contemplated that the vehicle may be any mobile platform, such as an airplane, all-terrain vehicle (ATV), boat, personal movement apparatus, robot and the like to accomplish the purposes of this disclosure.

The vehicle 10 includes a body 12 defining a vehicle interior or passenger compartment 14. The vehicle 10 also includes a plurality of doors 16 and 18, with only one door 16 and 18 visible from the perspective of FIG. 1. The first door 16 may be movably connected to the vehicle body 12 proximate a passage 15 in the vehicle body 12. The second door 18 is movably connected to the vehicle body 12 proximate the passage 15 and disposed adjacent the first door 16. The vehicle 10 may be configured as a 4-door passenger sedan as shown, a sport utility vehicle, a pickup truck, or any other vehicle having multiple rows of seats and thus doors 18 positioned to the rear of the doors 16.

Generally, the vehicle interior 14 is accessible through the passage 15 defined in the vehicle body 12. Therefore, when a passenger desires to enter or exit the vehicle interior 14, the passenger opens or closes the doors 16, 18 to allow ingress or egress through the passage 15. As such, the doors 16, 18 are movable between an open position and a closed position relative to the vehicle interior 14. Each door 16, 18 is hinged or otherwise attached to the body 12 to provide access to the vehicle interior 14. As shown in the Figures, door 16 provides access to front seats (not shown) in the vehicle interior 14 of the vehicle 10 such as a driver seat and a front passenger seat. Door 18 provides access to one or more rear rows of seats in the vehicle interior 14.

The doors 16, 18 may be opened from the inside by an inner door handle (not shown) and/or may be opened from the outside by a first or exterior door handle 20. The vehicle 10 and/or the door 12 includes an inner panel (not shown) and an outer panel 22 coupled to each other to define the doors 16, 18. The outer panel 22 of the doors 16, 18 has an outer surface visible from outside of the vehicle interior 14. The inner panel and the outer panel 22 of each door 16, 18 may be arranged to define a cavity between the inner and outer panels to receive a window assembly 24 that may include one or more windows 26 movable relative to the inner panel and outer panel 22 into and out of the cavity.

As shown in the Figures, the first door 16 includes a first window assembly 24 while the second door 18 includes a second window assembly 28. Each window assembly 24 may include at least one window actuator 30, such as a window motor and a window toggle switch 32 in communication with the actuator 30. The windows 26 of each of the first window assembly 24 and second window assembly 28 may be configured as moveable panes of glass such that the window actuators 30 translate generally vertically within an opening 34 in the doors 16, 18 to linearly open and close, a respective one of the first and second window assemblies 24, 28 with respect to the opening 34 in the corresponding door 16, 18 anywhere between and inclusive of a first or fully-closed position and at least one second or at least partially open position. It is contemplated that the at least one second position may also include a fully-opened position.

The window toggle switch 32 may be positioned on an interior surface of the doors 16, 18, on another portion of the vehicle interior 14 and/or as part of a remotely controlled device (not shown). The window toggle switch 32 is in electrical communication with a controller 36 and the window actuator 30. It is also understood that one or more switches 32 may control one or more window assemblies 24.

Movement of the window toggle switch 32 requests the energizing of a respective window actuator 30 in a direction. In one non-limiting example, when a passenger of the vehicle 10 operates the window toggle switch 32 for a given window assembly 24, 28 in a first or a second direction, the window actuator 30 for the selected window assembly 24, 28 is commanded, via the controller 36, to move the window 26 toward a respective first or fully-closed position or at least one second or open position within the window opening 34 of the respective door 16, 18.

The controller 36 may be, by way of non-limiting example, a body control module or a door control module. The controller 36 may be configured to receive and transmit signals, to process information and provide commands to systems and components to which the controller 36 is operatively connected or in communication. The controller 36, as provided herein, may be operatively connected to or in communication with the interior door handle, exterior door handle 20, the window assembly 24, one or more devices, a door unlatching actuation mechanism, the window actuator or regulating mechanism 30, and various sensors and switches associated therewith. The controller 36 may be configured to monitor one or more vehicle operating conditions as will be described in greater detail below.

The controller 36 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics. In certain embodiments, the controller 36 may also include incorporate one or more sensors and/or one or more other systems. In addition, it will be appreciated that the controller 36 may otherwise differ from the embodiment depicted in the Figures. For example, the controller 36 may be coupled to or may otherwise utilize one or more remote computer systems and/or other control systems.

The controller 36 is in communication with a set of sensors, generally referenced by numeral 38. Sensors 38 may monitor various vehicle operating parameters. In one embodiment, sensors 38 include at least one vehicle speed sensor 40 and at least one window position sensor 42. The vehicle speed sensor 40 may be configured to measure a vehicle speed to determine a value indicative of the speed of the vehicle 10 with respect to a surface on which the vehicle 10 travels.

In one possible embodiment, the vehicle speed sensor 40 may be embodied as a wheel speed sensor positioned with respect to a corresponding road wheel of the vehicle 10. In such an embodiment, the vehicle speed sensor 40 measures a rotational speed of the wheel as the wheel rotates about an axis of rotation, with this measured wheel speed being used by the controller 36 as the vehicle speed. In an alternative embodiment, the speed of the vehicle 10 may be measured via a transmission output speed sensor (not shown), which is operable to measure a rotational speed of an output member of a transmission (not shown), with the output speed used as the vehicle speed of the vehicle 10.

The controller 36 is in further communication with one or more window position sensors 42. The one or more window position sensors 42 cooperates with the first and second window assemblies 24, 28 and transmit a signal to the controller 36 representative of the window position relative to the opening 34 in the door 16, 18 describing an opened or a closed position each of the window assemblies 24, 28. Additionally, the position of a given window 26 of the first and second window assemblies 24, 28 may be measured by the window position sensors 42 relative to the position of the window actuator 30 or as a position of the window 26 within the allowable range of the window motion. It is contemplated that some vehicle designs permit a window 26 of the second or rear window assembly 28 to be only partially-opened. In such a case, the allowable range of motion defines the fully-opened position by its allowed range of motion limit as opposed to an absolute fully-opened position.

Referring additionally now to FIG. 2, the vehicle body 12 includes an access opening which is defined by at least a first door interface portion and a second door interface portion. The second interface portion further defines a pillar 52 which divides the access opening into a front door opening 44 for attaching a first or front door 16, and a rear door opening 46 for attaching a second or rear door 18. As is shown in FIG. 1, first or front door 16 includes a window trim panel 54 extending generally vertically from the outer door panel 22 and relative to the window opening 34. Trim panel 54 may be integrally formed as part of the outer door panel 22 or may be a separately secured to the door 16. The trim panel 54 at least partially covers the pillar 52 so the pillar 52 is not visible when the door 16 is placed in a closed position proximate the vehicle body 12.

The rear or second door 18 further includes a buffeting member 55. The buffeting member 55 may be positioned adjacent a forward surface of the second door 18 adjacent the window opening 34 in the door 18. Buffeting member 55 includes a window trim panel 56 extending generally vertically from the outer door panel 22 of the door 18 and relative to the window opening 34. Trim panel 56 may cooperate with front door trim panel 54 to cover the pillar 52 so the pillar 52 is not visible when the rear door 18 is placed in a closed position proximate the vehicle body 12. In one embodiment of the present disclosure, the window trim panel 56 may be movable between a first position and at least one second position in response to movement of the second window assembly 28 as will be described in greater detail.

As is shown in FIG. 1, the window trim panel 56 of the buffeting member 55 is positioned in the first or inactive position wherein the panel 56 is positioned adjacent with and generally planar to the window trim panel 54 on the first or front door 16 such that the window trim panels 54, 56 cover the pillar 52 of the vehicle body 12. The window trim panel 56 may be operatively connected to an adjustment mechanism, generally referenced by numeral 58. When placed in the at least one second position shown in FIGS. 2 and 3, the window trim panel 56 disrupts air flow over the panel 56 to reduce wind buffeting that may occur if the rear window 18 is opened while the front window 16 is closed.

The adjustment mechanism 58 may adjust the position of the window trim panel 56 from the first position to the at least one second position as shown in FIGS. 2 and 3. As will be described in greater detail below, the window trim panel 56 may be adjusted from the first position to the at least one second position by the adjustment mechanism 58 in response to the movement of the second window assembly 28 from a fully closed position to at least one open position. In one non-limiting embodiment of the disclosure, the adjustment mechanism 58 may be configured as a cam linkage. A spring, generally referenced by numeral 60, may cooperate with the adjustment mechanism 58 and window trim panel 56 to bias the window trim panel 56 between the first position and the at least one second position.

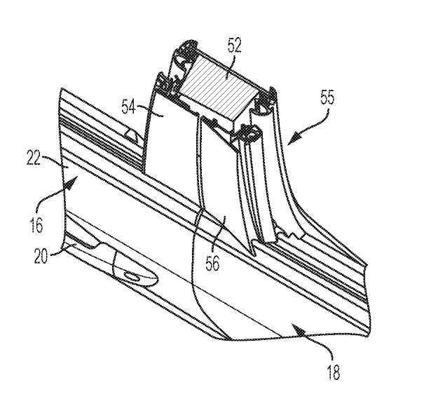

Referring now to FIG. 4, a method for deploying a wind buffeting system for a vehicle is disclosed. The method, generally referenced by numeral 100, may initiate at box or step 102. The controller 36 monitors one or more vehicle operating conditions and/or receives information from other vehicle systems indicating vehicle operation conditions. At step or box 104, the controller 36 detects whether a speed of the vehicle exceeds a predetermined speed threshold value. The controller 36 may monitor the one or more speed sensors 40 to detect whether the vehicle 10 is traveling at a speed that exceeds the predetermined speed threshold value. In one non-limiting example, the predetermined speed threshold value may be about ten miles per hour (10 mph).

If the controller 36 determines that the vehicle 10 is operating a speed less than or equal 10 mph, the method returns to the initial monitor box or step 102 to allow the controller 36 to continue monitoring the operation state of the vehicle 10 as represented by line 106. If the controller 36 detects that the vehicle 10 is operating at a speed greater than the predetermined speed value of about 10 mph, the method moves to box or step 108. It is also contemplated that the controller 36 may determine whether the vehicle is traveling at a speed greater than or equal to the predetermined speed value for the method to move to box or step 108.

At box or step 108, the controller 36 determines the position of the second or rear window assembly 28 with the one or more window position sensors 42. The window position sensors 42 will detect whether the second window 28 is in a closed position or at least one open position. If the controller 36 determines the second window assembly 28 is fully closed, the method returns to the initial monitor box or step 102 to allow the controller 36 to continue monitoring the operation state of the vehicle as represented by line 110. If the controller 36 detects the window is at least partially positioned in an open position, the method moves to box or step 112.

At box or step 112, the controller detects the condition of the first or front window assembly 24 with the one or more window position sensors 42. If the controller 36 determines the first window assembly 24 is at least partially open, the method returns to the initial monitor box or step 102 to allow the controller 36 to continue monitoring the operation state of the vehicle as represented by line 114. If the controller 36 detects the first window assembly 24 is in a fully closed position, the controller engages the adjustment mechanism 58 to move the window trim panel 56 of the buffeting member 55 from the first position to the at least one second or deployed position as represented by box or step 116.

Deployment of the window trim panel 56 on the front edge of the second door 18 forward of the window opening 34 into the at least one second position shown in FIG. 3 disrupts the air flow to the at least partially open second window assembly 28. The resultant disruption reduces the pulsations of air associated with wind buffeting if the second window assembly 28 is opened before or without the opening of the first window assembly 24 above a predetermined speed threshold.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

1. A method of controlling wind buffeting for a vehicle comprising:
providing a first window assembly movable between a closed position and at least one open position;
providing a second window assembly movable between a closed position and at least one open position;
detecting, with the controller, whether a speed of the vehicle exceeds a predetermined speed value;
determining, with the controller, the position of the second window assembly in response to the controller detecting that the speed of the vehicle exceeds the predetermined speed value;
determining, with the controller, the position of the first window assembly in response to the controller determining that the second window assembly is in the at least one open position;
providing a buffeting member adjacent the second window assembly, the buffeting member including a trim panel and an adjustment mechanism operatively connected to the trim panel to translate the trim panel between a first position and at least one second position; and
adjusting the buffeting member from the first position to the at least one second position in response to the controller determining that the first window assembly is in the closed position.

2. The method of claim 1 further comprising monitoring, with the controller, one or more vehicle operating conditions.

3. The method of claim 2 wherein the step of monitoring, with the controller, one or more vehicle conditions further comprises:
providing at least one speed sensor in communication with the controller to detect the speed of the vehicle; and
providing at least one window position sensor in communication with one or more of the first window assembly and second window assembly to detect the position of windows of the first and second window assemblies between the first position and the at least one second position.

4. The method of claim 1 wherein the predetermined speed value is a vehicle speed threshold value greater than 10 miles per hour (mph).

5. The method of claim 1 wherein the step of providing the first window assembly further comprises providing a first door movably connected to a vehicle body, wherein the first door receives and is operatively connected to the first window assembly.

6. The method of claim 5 wherein the step of providing the second window assembly further comprises providing a second door movably connected to a vehicle body and disposed adjacent the first door on the vehicle body, wherein the second door receives and is operatively connected to the second window assembly.

7. The method of claim 6 wherein the step of providing the buffeting member further comprises operatively connecting a portion of the buffeting member to the second door adjacent the second window assembly.

8. The method of claim 1 wherein the adjustment mechanism of the buffeting member further comprises a cam linkage.

9. The method of claim 1 wherein the step of providing the buffeting member further comprises providing a spring operatively connected to the trim panel to bias the trim panel between the first position and the at least one second position.

10. A method of controlling wind buffeting for a vehicle having a first door movably connected to a vehicle body and a second door movably connected to the vehicle body and disposed adjacent to the first door, the method comprising:
providing a first window assembly received by and operatively connected to the first door, wherein the first window assembly is movable between a closed position and at least one open position;
providing a second window assembly received by and operatively connected to the second door, wherein the second window assembly is movable between a closed position and at least one open position;
monitoring, with the controller, one or more vehicle conditions;
detecting, with the controller, whether a speed of the vehicle exceeds a predetermined speed value;
determining, with the controller, the position of the second window assembly in response to the controller detecting that the speed of the vehicle exceeds the predetermined speed value;
determining, with the controller, the position of the first window assembly in response to the controller determining that the second window assembly is in the at least one open position;
providing a buffeting member adjacent the second window assembly, the buffeting member including a trim panel and an adjustment mechanism operatively connected to the trim panel to translate the trim panel between a first position and at least one second position; and
adjusting the buffeting member from the first position to the at least one second position in response to the controller determining that the first window assembly is in the closed position.

11. The method of claim 9 wherein the predetermined speed value is a vehicle speed threshold value greater than 10 miles per hour (mph).

12. The method of claim 9 wherein the adjustment mechanism of the buffeting member further comprises a cam linkage.

13. The method of claim 9 wherein the step of providing the buffeting member further comprises adjustably connecting a portion of the trim panel to the second door adjacent the second window assembly.

14. The method of claim 9 wherein the step of monitoring, with the controller, one or more vehicle conditions further comprises:
providing at least one speed sensor in communication with the controller to detect the vehicle speed; and
providing at least one window position sensor in communication with one or more of the first window assembly and second window assembly to detect the position of windows of the first and second window assemblies between the first position and the at least one second position.

15. A wind buffeting system for a vehicle having a first door movably connected to a vehicle body and a second door movably connected to the vehicle body and disposed adjacent to the first door comprising:
a first window assembly operatively connected to the first door, wherein the first window assembly is movable between a closed position and at least one open position;
a second window assembly operatively connected to the second door, wherein the second window assembly is movable between a closed position and at least one open position;
a buffeting member operatively connected to a portion of the second door adjacent the second window assembly, the buffeting member including a trim panel and an adjustment mechanism operatively connected to the trim panel to adjust the trim panel between a first position and at least one second position; and
a controller operatively connected with the first and second window assemblies, wherein the controller:
detects a speed of the vehicle to determine if the vehicle speed exceeds a predetermined speed threshold value,
determines the position of the second window assembly in response to the controller detecting that the speed of the vehicle exceeds the predetermined speed threshold value,
determines the position of the first window assembly in response to the controller determining the second window assembly is in the at least one open position, and
signals adjustment of the trim panel of the buffeting member from the first position to the at least one second position in response to the controller determining the first window assembly is in the closed position.

16. The system of claim 15 wherein the predetermined speed threshold value is a vehicle speed value greater than 10 miles per hour (mph).

17. The system of claim 15 further comprising a plurality of sensors in communication with the controller, the plurality of sensors including at least one vehicle speed sensor to detect the vehicle speed and at least one window position sensor in communication with one or more of the first window assembly and second window assembly to detect the position of windows of the first and second window assemblies.

18. The system of claim 15 wherein the adjustment mechanism of the buffeting member further comprises a cam linkage.

19. The system of claim 15 wherein the buffeting member is adjustably connected a portion of the second door adjacent the second window assembly.

20. The system of claim 15 wherein the trim panel of the buffeting member at least partially covers a portion of a vehicle body when the trim panel is in the first position.
